(19) United States
(12) Patent Application Publication
(10) Pub. No.: US 2008/0314532 A1
(43) Pub. Date: Dec. 25, 2008

(54) WINDOW BLIND SLAT

(75) Inventor: Po-Yu CHEN, Taichung City (TW)

Correspondence Address: BROWDY AND NEIMARK, P.L.L.C.;624 NINTH STREET, NW, SUITE 300, WASHINGTON, DC, 20001-5303, US

(73) Assignee: Chin-Fu Chen, Taichung (TW)

(21) Appl. No.: 11/862,411

(22) Filed: Sep. 27, 2007

(30) Foreign Application Priority Data
Jun. 20, 2007 (TW) 96210011

(51) Int. Cl. E06B 9/386

(52) U.S. Cl. 160/236

(57) ABSTRACT

A window blind slat includes a metal sheet, a bottom layer, and a top layer. The metal sheet includes a top side and a bottom side. The bottom layer is attached to the bottom side of the metal sheet, having two end parts curved and then attached to the top side of the metal sheet. The top layer is attached to the top side of the metal sheet and top sides of the two end parts of the bottom layers.

### BACKGROUND OF THE INVENTION

1. Field of the Invention

The present invention relates generally to window blind slats, and more particularly, to a window blind slat having enhanced visual effect.

2. Description of the Related Art

To prevent the sunshine from projection into the house, curtains made of fabric or blinds composed of slats are mounted to the windows in the house, wherein the slats of the blinds are mostly made of aluminum alloy to enable the windows blinds to be lightweight and fireproof.

Since the slats made of aluminum look monotonous in appearance, sometimes a transfer paper applied to the slats can enable the surfaces of the slats to form a pattern or marking for enhancement of visual effect in appearance. However, the surfaces of the slats are subject to reflection to refrain the pattern or marking on the surfaces of the slats from display, further deteriorating the visual aestheticism of the slats in appearance.

### SUMMARY OF THE INVENTION

The primary objective of the present invention is to provide a window blind slat, whose visual effect is different from the prior art.

The foregoing objective of the present invention is attained by the window blind slat composed of a metal sheet, a bottom layer, and a top layer. The metal sheet includes a top side and a bottom side. The bottom layer is attached to the bottom side of the metal sheet, having two end parts curved and then attached to the top side of the metal sheet. The top layer is attached to the top side of the metal sheet and top sides of the two end parts of the bottom layers.

### BRIEF DESCRIPTION OF THE DRAWINGS

FIG. 1 is a schematic view of a process of manufacturing the window blind sheet according to a preferred embodiment of the present invention.

FIG. 2 is a sectional view taken along a line 2-2 indicated in FIG. 1.

FIG. 3 is a sectional view taken along a line 3-3 indicated in FIG. 1.

FIG. 4 is a sectional view taken along a line 4-4 indicated in FIG. 1.

FIG. 5 is a sectional view taken along a line 5-5 indicated in FIG. 1.

### DETAILED DESCRIPTION OF PREFERRED EMBODIMENTS

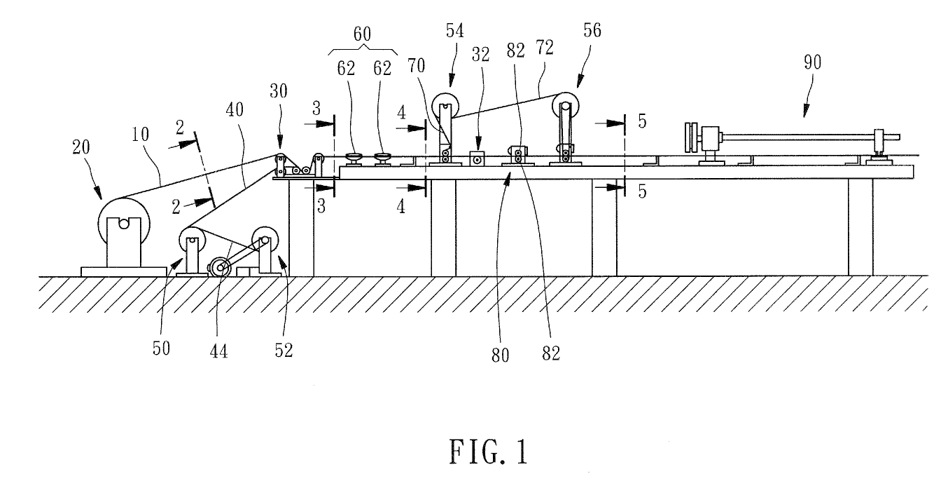

Referring to FIG. 1, a window blind of a preferred embodiment of the present invention can be manufactured by the following steps.

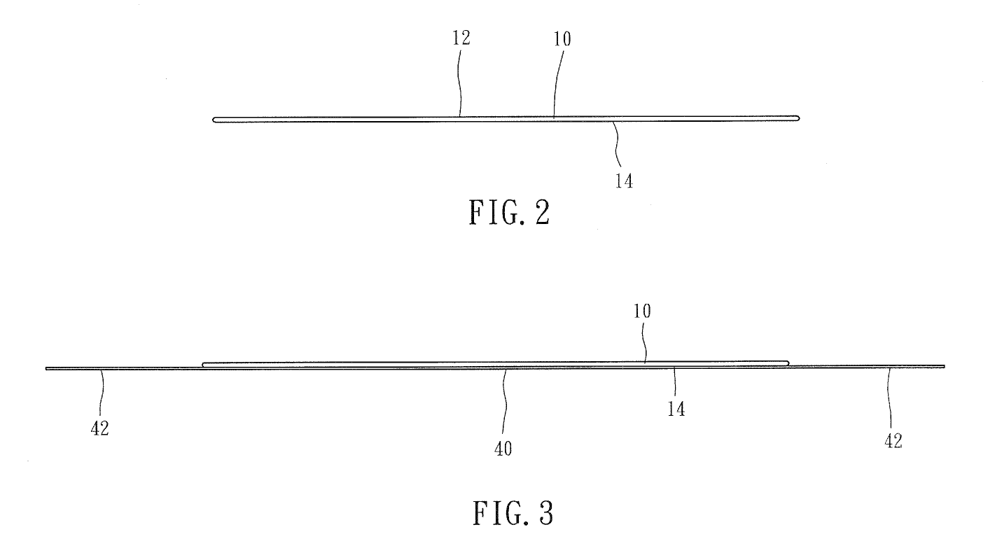

First, prepare a metal sheet 10 for being processed. The metal sheet 10 is made of aluminum, having a top side 12 and a bottom side 14, as shown in FIG. 2. One end of the metal sheet 10 is rolled onto a rolling wheel 20 and the other end thereof is connected to a driving belt (not shown). Through the rolling wheel 20 and the driving belt, the metal sheet 10 can be stably driven by a first retracting device 30 and a second retracting device 32 to move toward the first and second retracting devices 30 and 32.

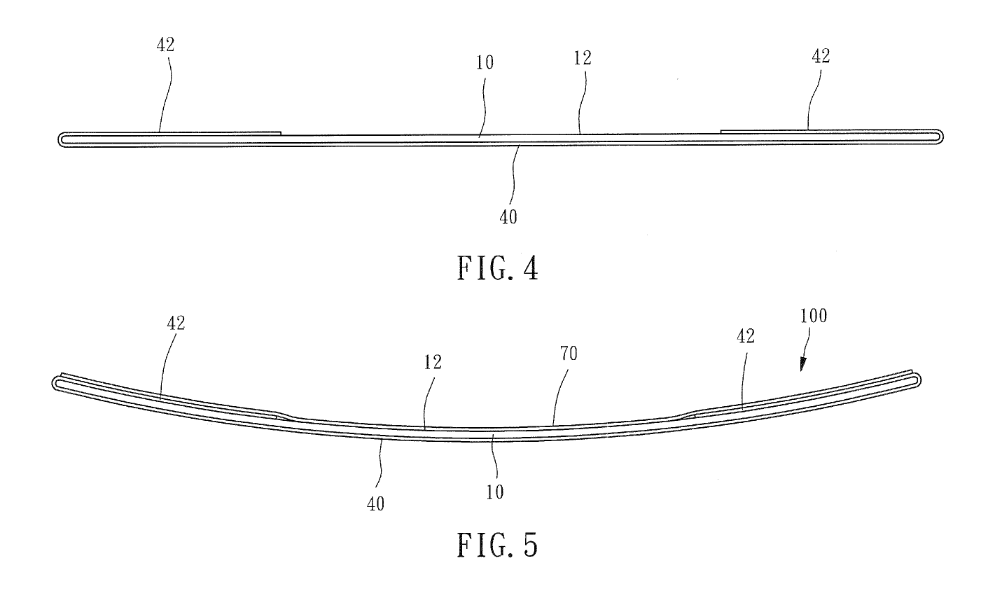

Prepare a bottom layer 40 made of leather, or alternatively, polyurethane (PU), polyvinyl chloride (PVC), or resin. One end of the bottom layer 40 is rolled onto a first leather rolling wheel 50 for peeling an adhesive paper 44 from a top side of the bottom layer 40 through rolling movement of a first adhesive-paper rolling wheel 52. The other end of the bottom layer 40 is connected to the driving belt for delivering the bottom layer 40 toward the first retracting device 30, in coordination with the first retracting device 30, to attach the top side of the bottom layer 40 to the bottom side 14 of the metal sheet 10. As shown in FIG. 3, the bottom layer 40 is larger than the metal sheet 10 in breath. Next, operate a curving device 60 having a plurality of rubber rollers 62 to curve two end parts 42 of the bottom layer 40 passing through the rubber rollers 62 to attach the two end parts 42 to the top side 12 of the metal sheet 10, wherein the two end parts 42 are spaced from each other for a predetermined interval, as shown in FIG. 4.

Prepare a top layer 70 made of leather, or alternatively PU, PVC, or resin. One end of the top layer 70 is rolled onto a second leather rolling wheel 54 for peeling an adhesive paper 72 from a bottom side of the top layer 70 through the rolling movement of a second adhesive-paper rolling wheel 56. The other end of the top layer 70 is connected to the driving belt for attaching the bottom side of the top layer 70 to the top side 12 of the metal sheet 10 and top sides of the two end parts 42 of the bottom layer 40, in coordination with the second retracting device 32. Next, operate a squeezing device 80 having two squeezing rollers 82 to squeeze the metal sheet 10, the bottom layer 40, and the top layer 70 passing through the two squeezing rollers 82 to produce a window blind slat 100 having a convex surface at a top side thereof and a concave surface at a bottom side thereof. Referring to FIG. 5, finally, operate a cutting device 90 to cut a part having a predetermined length from the window blind slat 100.

In light of the above embodiment of the present invention, the present invention includes the following advantages.

1. Because the top and bottom sides of the metal sheet are attached to the top and bottom layers made of leather, the whole surface of the window blind slat provides better visual effect and the surfaces of the top and bottom layers are formed with the pattern or marking to enhance aestheticism in appearance.

2. Because the material that each of the top and bottom layers is made is variable, the surface of the whole window blind slat enables high value-added perception.

Although the present invention has been described with respect to a specific preferred embodiment thereof, it is no way limited to the details of the illustrated structures but changes and modifications may be made within the scope of the appended claims.

What is claimed is:

1. A window blind slat comprising:
a metal sheet having a top side and a bottom side;
a bottom layer attached to a bottom side of said metal sheet and having two end parts curved and then attached to a top side of said metal sheet; and
a top layer attached to the top side of said metal sheet and top sides of said two end parts of said bottom layer.

2. The window blind slat as defined in claim 1, wherein said metal sheet is made of aluminum alloy.

3. The window blind slat as defined in claim 1, wherein each of said bottom and top layers is made of a material selected from a group consisting of leather, PU, PVC, and resin.

4. The window blind slat as defined in claim 1, wherein said bottom layer is provided with a convex surface at a bottom side thereof and said top layer is provided with a concave surface at a top side thereof.

5. The window blind slat as defined in claim 1, wherein said two end parts of said bottom layer is spaced from each other for a predetermined interval.
